(19) United States
(12) Patent Application Publication
(10) Pub. No.: US 2004/0023061 A1
(43) Pub. Date: Feb. 5, 2004

(54) Electroluminescent device

(75) Inventors: Poopathy Kathirgamanathan, North Harrow (GB); Selvadurai Selvaranjan, Surrey (GB); Sivagnanasundram Surendrakumar, Edgware (GB)

Correspondence Address: Dr. Marta E. Delsignore PhD, Goodwin Procter L.L.P., 599 Lexington Avenue, New York, NY, 10022, US

(73) Assignee: Elam-T Limited

(21) Appl. No.: 10/442,641

(22) Filed: May 21, 2003

Related U.S. Application Data
(63) Continuation of application No. PCT/GB01/05135, filed on Nov. 21, 2001.

(30) Foreign Application Priority Data
Nov. 21, 2000 (GB) 0028317.6

(51) Int. Cl. H05B 33/12

(52) U.S. Cl. 428/690; 428/917; 313/504; 313/506; 257/40

(57) ABSTRACT

The use of unsubstituted or substituted polymer of an amino substituted aromatic compound as a hole transporting and/or hole injecting layer in an electroluminescent device using an organic metal complex as the electroluminescent material produced improved performance of the device.

The present invention relates to electroluminescent devices.

Materials which emit light when an electric current is passed through them are well known and used in a wide range of display applications. Liquid crystal devices and devices which are based on inorganic semiconductor systems are widely used, however these suffer from the disadvantages of high energy consumption, high cost of manufacture, low quantum efficiency and the inability to make flat panel displays.

Organic polymers have been proposed as useful in electroluminescent devices, but it is not possible to obtain pure colours, they are expensive to make and have a relatively low efficiency.

Another compound which has been proposed is aluminium quinolate, but this requires dopants to be used to obtain a range of colours and has a relatively low efficiency.

Patent application WO98/58037 describes a range of lauthanide complexes which can be used in electroluminescent devices which have improved properties and give better results. Patent Applications PCT/GB98/01773, PCT/GB99/03619, PCT/GB99/04030, PCT/GB99/04024, PCT/GB99/04028, PCT/GB00/00268 describe electroluminescent complexes, structures and devices using rare earth chelates.

U.S. Pat. No. 5,128,587 discloses an electroluminescent device which consists of an organometallic complex of rare earth elements of the lanthanide series sandwiched between a transparent electrode of high work function and a second electrode of low work function with a hole conducting layer interposed between the electroluminescent layer and the transparent high work function electrode and an electron conducting layer interposed between the electroluminescent layer and the electron injecting low work function anode. The hole conducting layer and the electron conducting layer are required to improve the working and the efficiency of the device. The hole transporting layer serves to transport holes and to block the electrons, thus preventing electrons from moving into the electrode without recombining with holes. The recombination of carriers therefore mainly takes place in the emitter layer.

We have devised electroluminescent devices with improved hole transporting and/or hole injecting layer formed of a polycyclic aromatic such as a polyaniline copolymer.

Polymers of aniline known as polyanilines are known compounds and are disclosed in GB patents 2151242, 2169608, 2184738 and 2124635.

EP0302601A1 discloses polyanilines which are copolymers of a substituted aniline of general formula

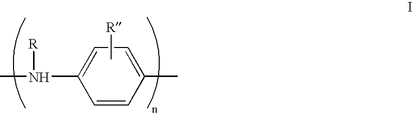

where R is hydrogen, C1-18 alkyl, C1-6 alkoxy, amino, chloro, bromo, hydroxy or the group

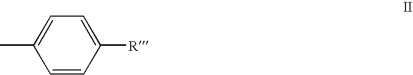

where R″ is in the ortho- or meta-position and is alky or aryl and R′″ is hydrogen, C1 -6 alkyl or aryl with at least one other monomer of formula I above.

We have now discovered that these unsubstituted or substituted polyanilines can be used as hole transporting and/or hole injecting materials in electroluminescent devices.

According to the invention there is provided an electroluminescent device comprising sequentially (i) a first electrode, (ii) a layer of an unsubstituted or substituted polymer of an amino substituted aromatic compound as a hole transporting and/or hole injecting layer, (iii) a layer consisting of an electroluminescent material and (iv) a second electrode.

The preferred polymer of an amino substituted aromatic compound are polyanilines and a polyaniline usefull in the present invention has the general formula

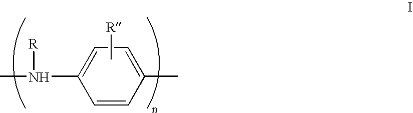

where R is in the ortho- or meta-position and is hydrogen, C1-18 alkyl, C1-6 alkoxy, amino, chloro, bromo, hydroxy or the group

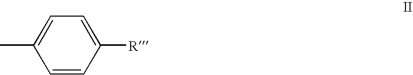

where R″ is alky or aryl and R′″ is hydrogen, C1-6 akyl or aryl with at least one other monomer of formula I above and a is 1 to 50, preferably the weight average molecular weight of the polyaniline is of the order of 30,000.

A preferred class of polyanilines usefull in the present invention have the general formula

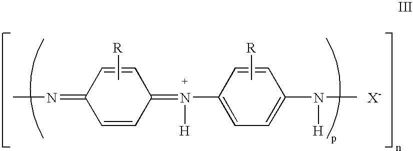

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulosesulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate, an example of an arenedicarboxylate is phthalate and an example of arenecarboxylate is benzoate

A preferred method of forming electroluminescent devices comprising an electroluminescent device comprising sequentially (i) a first electrode, (ii) a layer of an unsubstituted or substituted polymer of an amino substituted aromatic compound as a hole transporting and/or hole injecting layer, (iii) a layer consisting of an electroluminescent material and (iv) a second electrode is by vacuum deposition or vacuum sublimation of layers of materials forming the electroluminescent device for example the unsubstituted or substituted polymer of an amino substituted aromatic compound is evaporated and deposited on the first electrode or, if there is layer of a material such as a buffer layer, the unsubstituted or substituted polymer of an amino substituted aromatic compound is deposited on such a layer. We have found that protonated polymers of the unsubstituted or substituted polymer of an amino substituted aromatic compound such as a polyaniline are difficult to evaporate or cannot be evaporated, however we have surprisingly found that if the unsubstituted or substituted polymer of an amino substituted aromatic compound is deprotonated the it can be easily evaporated i.e. the polymer is evaporable.

The invention preferably uses evaporable deprotonated polymers of unsubstituted or substituted polymer of an amino substituted aromatic compound.

The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and deprotonating. Methods of preparing polyanilines are described in the article by A. G. MacDarmid and A. F. Epstein, Faraday Discussions, Chem Soc.88 P319 1989.

The conductivity of the polyaniline is dependant on the degree of protonation with the maximum conductivity being when the degree of protonation is between 40 and 60% e.g. about 50% for example.

Preferably the polymer is substantially filly deprotonated.

A polyaniline can be formed of octamer units i.e. p is four e.g.

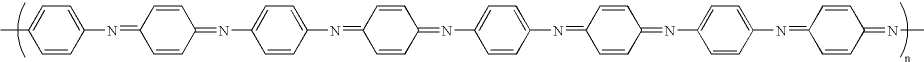

The polyanilines can have conductivities of the order of 1×10⁻¹ Siemen cm⁻¹ or higher.

The aromatic rings can be unsubstituted or substituted e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino antacenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted e.g. by a group R as defined above.

The polyanilines can be deposited on the first electrode by conventional methods e.g. by vacuum evaporation, spin coating, chemical deposition, direct electrodeposition etc. preferably the thickness of the polyaniline layer is such that the layer is conductive and transparent and can is preferably from 20 nm to 200 nm. The polyanilines can be protonated or de-protonated, when they are protonated they can be dissolved in a solvent and deposited as a film, when they are de-doped they are solids and as sated above can be deposited by vacuum evaporation i.e. by sublimation.

The first electrode is preferably a transparent substrate which is a conductive glass or plastic material which acts as the cathode, preferred substrates are conductive glasses such as indium tin oxide coated glass, but any glass which is conductive or has a conductive layer can be used. Conductive polymers and conductive polymer coated glass or plastics materials can also be used as the substrate.

The electroluminescent material is preferably an organometallic complex such as a rare earth chelate.

Rare earth chelates are known which fluoresce in ultra violet radiation and A. P. Sinba (Spectroscopy of Inorganic Chemistry Vol. 2 Academic Press 1971) describes several classes of rare earth chelates with various monodentate and bidentate ligands.

Group III A metals and lanthanides and actinides with aromatic complexing agents have been described by G. Kallistratos (Chimica Chronika, New Series, 11, 249-266 (1982)). This reference specifically discloses the Eu(III), Tb(III), U(III) and U(IV) complexes of diphenyl-phosponamidotriphenyl-phosphoran.

EP 0744451A1 also discloses fluorescent chelates of transition or lanthanide or actinide metals and the known chelates which can be used are those disclosed in the above references including those based on diketone and triketone moieties.

The electroluminescent compounds which can be used in the present invention are of formula

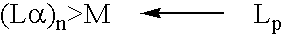

where Lα and Lp are organic ligands, M is a rare earth, transition metal, lanthanide or an actinide and n is the valence state of the metal M. The ligands Lα can be the same or different and there can be a plurality of ligands Lp which can be the same or different.

For example (L₁)(L₂)(L₃)(L . . . )M (Lp) where M is a rare earth, transition metal, lanthanide or an actinide and (L₁)(L₂)(L₃)(L . . . ) are the same or different organic complexes and (Lp) is a neutral ligand. The total charge of the ligands (L₁)(L₂)(L₃)(L . . . ) is equal to the valence state of the metal M.

Where there are 3 groups Lα which corresponds to the III valence state of M the complex has the formula (L₁)(L₂)(L₃)M (Lp) and the different groups (L₁)(L₂)(L₃) may be the same or different.

Any metal ion having an unfilled inner shell can be used as the metal and the preferred metals are selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III), ER(III).

Other organometallic electroluminescent materials which can be used in the present invention are of formula (Lₙ)ₙM₁M₂ and (Lₙ)ₙM₁ M₂ (Lₚ), where Lₚ is a neutral ligand where M₁ is a rare earth, transition metal, lanthide or an actinide, M₂ is a non rare earth metal, Lₙ is an organic complex such as Lα and n is the combined valence state of M₁ and M₂.

The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium, titanium, vanadium, zirconium, tantulum, molybdenum, rhodium, iridium, titanium, niobium, scandium, yttrium etc.

The non rare earth metal can be selected from lithium, sodium, potassium, rubidium, caesium, beryllium, magnesium, calcium, strontium, barium, copper, silver, gold, zinc, cadmium, boron, aluminium, gallium, indium, germanium, tin, antimony, lead, and metals of the first, second and third groups of transition metals e.g. manganese, iron, ruthenium, osmium, cobalt, nickel, palladium, platinum, cadmium, chromium titanium, vanadium, zirconium, tantalum, molybdenum, rhodium, iridium, titanium, niobium, scandium, yttrium etc.

Further electroluminescent compounds which can be used in the present invention are of general formula (Lα)ₙM₁M₂ where M₁ is the same as M above, M₂ is a non rare earth metal, Lα is a as above and n is the combined valence state of M₁ and M₂. The complex can also comprise one or more neutral ligands Lp so the complex has the general formula (Lα)ₙ M₁ M₂ (Lp), where Lp is as above. The metal M₂ can be any metal which is not a rare earth, transition metal, lanthanide or an actinide examples of metals which can be used include lithium, sodium, potassium, rubidium, caesium, beryllium, magnesium, calcium, strontium, barium, copper (I), copper (II), silver, gold, zinc, cadmium, boron, aluminium, gallium, indium, germanium, tin (II), tin (IV), antimony (II), antimony (IV), lead (II), lead (IV) and metals of the first, second and third groups of transition metals in different valence states e.g. manganese, iron, ruthenium, osmium, cobalt, nickel, palladium(II), palladium(IV), platinum(II), platinum(IV), cadmium, chromium, titanium, vanadium, zirconium, tantulum, molybdenum, rhodium, iridium, titanium, niobium, scandium, yttrium.

For example (L₁)(L₂)(L₃)(L . . . )M (Lp) where M is a rare earth, transition metal, lanthanide or an actinide and (L₁)(L₂)(L₃)(L . . . ) and (Lp) are the same or different organic complexes.

Further organometallic complexes which can be used in the present invention are binuclear, trinuclear and polynuclear organometallic complexes e.g. of formula (Lm)ₓM₁←M₂(Ln)_{y} e.g.

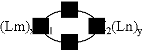

where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂.

In these complexes there can be a metal to metal bond or there can be one or more bridging ligands between M₁ and M₂ and the groups Lm and Ln can be the same or different.

By trinuclear is meant there are three rare earth metals joined by a metal to metal bond i.e. of formula

(Lm)ₓM₁-M₃(Ln)_{y}-M₂(Lp)_{z}

or

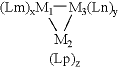

where M₁, M₂ and M₃ are the same or different rare earth metals and Lm, Ln and Lp are organic ligands Lα and x is the valence state of M₁, y is the valence state of M₂ and z is the valence state of M₃. Lp can be the same as Lm and Ln or different.

The rare earth metals and the non rare earth metals can be joined together by a metal to metal bond and/or via an intermediate bridging atom, ligand or molecular group.

For example the metals can be linked by bridging ligands e.g.

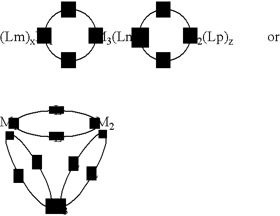

where L is a bridging ligand

By polynuclear is meant there are more than three metals joined by metal to metal bonds and/or via intermediate ligands

M₁-M₂-M₃-M₄

or

M₁-M₂-M₄- M₃

or

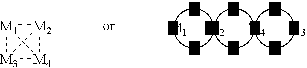

where M₁, M₂, M₃ and M₄ are rare earth metals and L is a bridging ligand.

Preferably Lα is selected from β diketones such as those of formulae

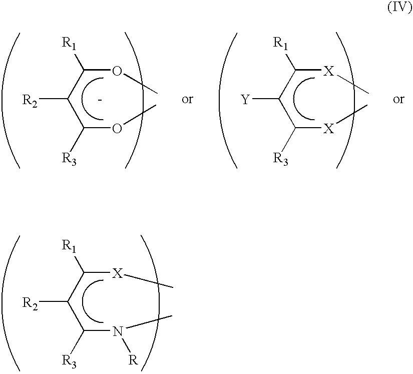

where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

Some of the different groups Lα may also be the same or different charged groups such as carboxylate groups so that the group L₁ can be as defined above and the groups L₂, L₃. . . can be charged groups such as

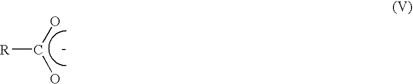

where R is R₁ as defined above or the groups L₁, L₂ can be as defined above and L_{3 . . . etc.} are other charged groups.

R₁, R₂ and R₃ can also be

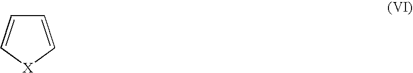

where X is O, S, Se or NH.

A preferred moiety R₁ is trifluoromethyl CF₃ and examples of such diketones are, banzoyltrifluoroacetone, p-chlorobenzoyltrifluoroacetone, p-bromotrifluoroacetone, p-phenyltrifluoroacetone, 1-naphthoyltrifluoroacetone, 2-naphthoyltrifluoroacetone, 2-phenathoyltrifluoroacetone, 3-phenathoyltrifluoroacetone, 9-anthroyltrifluoroacetonetrifluoroacetone, cinnamoyltrifluoroacetone, and 2-thenoyltrifluoroacetone.

The different groups Lα may be the same or different ligands of formulae

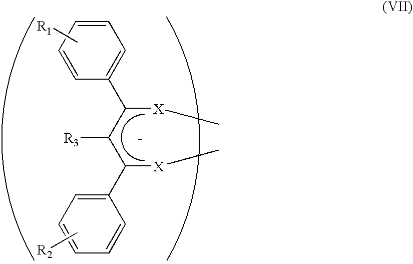

where X is O, S, or Se and R₁ R₂ and R₃ are as above.

The different groups Lα may be the same or different quinolate derivatives such as

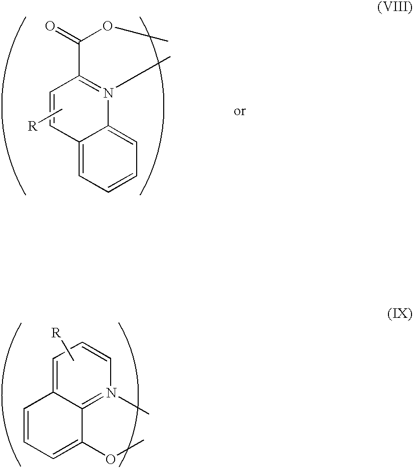

where R is hydrocarbyl, aliphatic, aromatic or heterocyclic carboxy, aryloxy, hydroxy or alkoxy e.g. the 8 hydroxy quinolate derivatives or

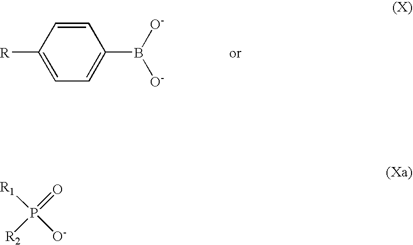

where R is as above or H or F or

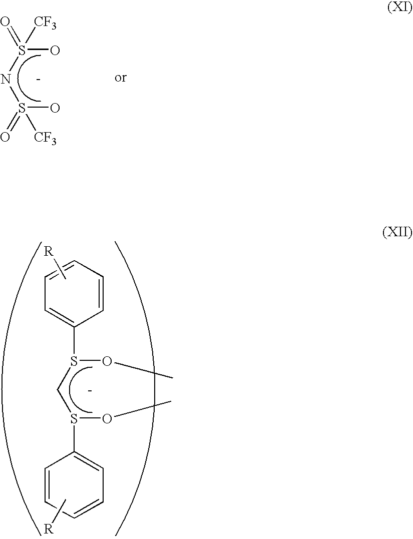

where R₅ is a substituted or unsubstituted aromatic, polycyclic or heterocyclic ring a polypyridyl group, R₅ can also be a 2-ethyl hexyl group so Lₙ is 2-ethythexanoate or R₅ can be a chair structure so that Lₙ is 2-acetyl cyclohexanoate or L can be

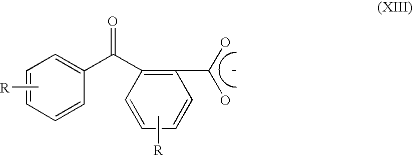

where R is as above e.g. alkyl, allenyl, amino or a fused ring such as a cyclic or polycyclic ring.

The different groups Lα may also be

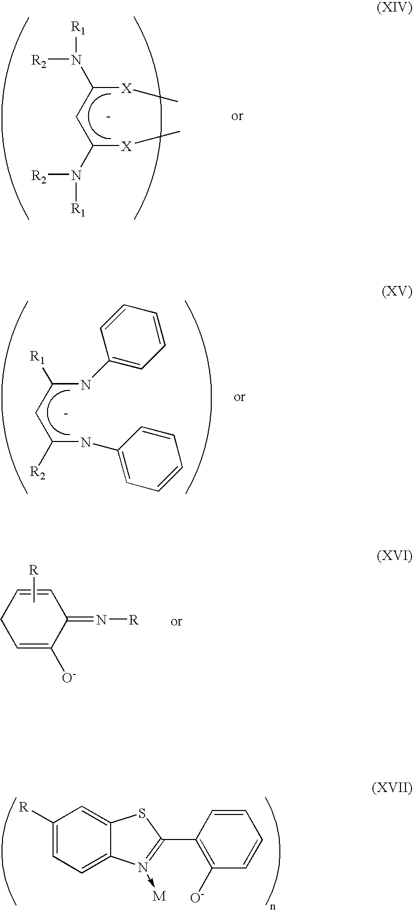

Where R R₁ and R₂ are as above.

As stated above the different groups Lα may also be the same or different carboxylate groups e.g.

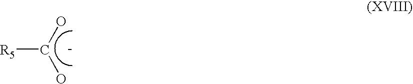

where R₅ is a substituted or unsubstituted aromatic, polycyclic or heterocyclic ring a polypyridyl group, R₅ can also be a 2ethyl hexyl group so Lₙ is 2-ethylhexanoate or R₅ can be a chair structure so that Lₙ is 2-acetyl cyclohexanoate.

Examples of β-diketones which are preferably used with non rare earth chelates are tris-(1,3-diphenyl-1-3-propanedione) (DBM) and suitable metal complexes are Al(DBM)₃, Zn(D)BM)₂ and Mg(DBM)₂, Sc(DBM)₃ etc.

A preferred β-diketone is when R₁ and/or R₃ are alkoxy such as methoxy and the metals are aluminium or scandium i.e. the complexes have the formula

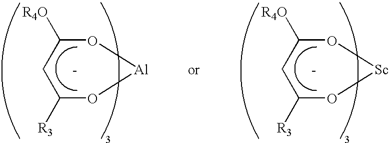

where R₄ is an alkyl group, preferably methyl and R₃ is hydrogen, an alkyl group such as methyl or R₄O.

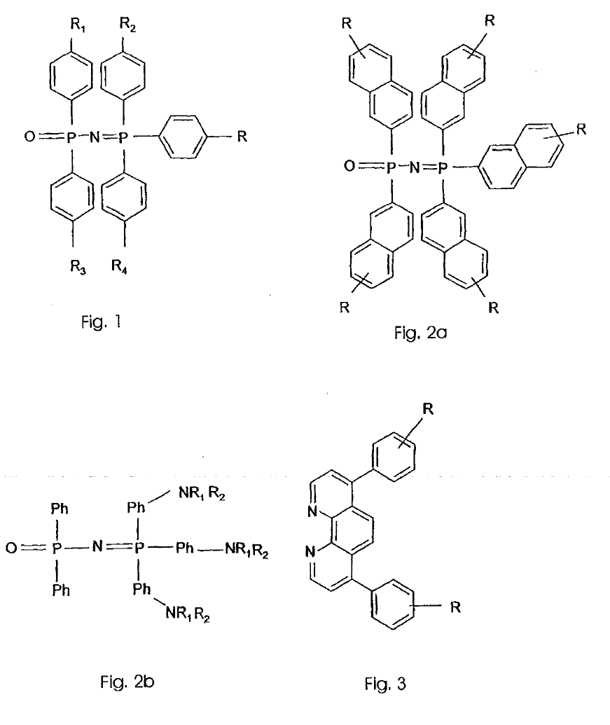

The groups Lₚ can be selected from

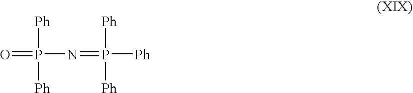

Where each Ph which can be the same or different and can be a phenyl (OPNP) or a substituted phenyl group, other substituted or unsubstituted aromatic group, a substituted or unsubstituted heterocyclic or polycyclic group, a substituted or unsubstituted fused aromatic group such as a naphthyl, anthracene, phenanthrene, perylene or pyrene group. The substituents can be for example an alkyl, aralkyl, alkoxy, aromatic, heterocyclic, polycyclic group, halogen such as fluorine, cyano, amino and substituted amino groups etc. Examples are given in FIGS. 1 and 2 of the drawings where R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups

—C—CH₂═CH₂—R

where R is as above.

Lₚ can also be compounds of formulae

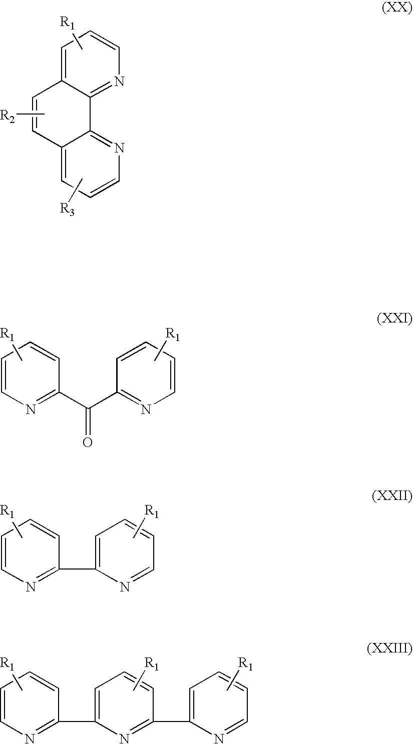

where R₁, R₂ and R₃ are as referred to above, for example bathophen shown in FIG. 3 of the drawings in which R is as above.

Lₚ ca also be

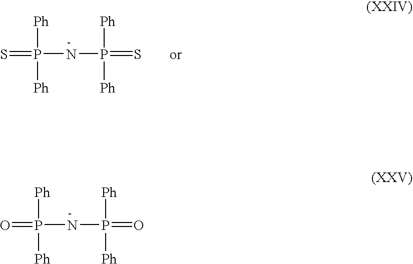

where Ph is as above.

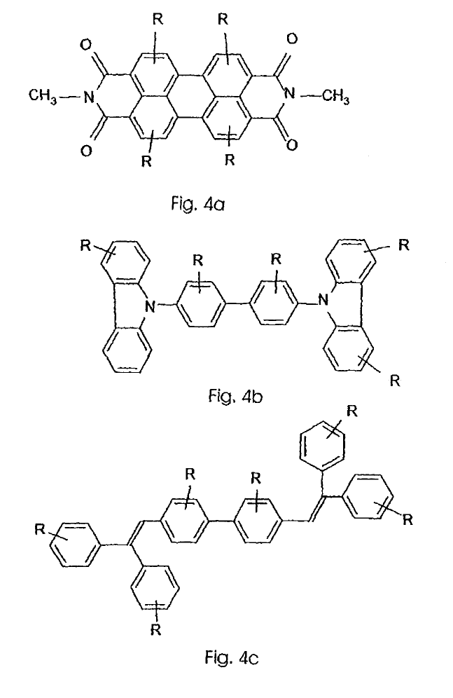

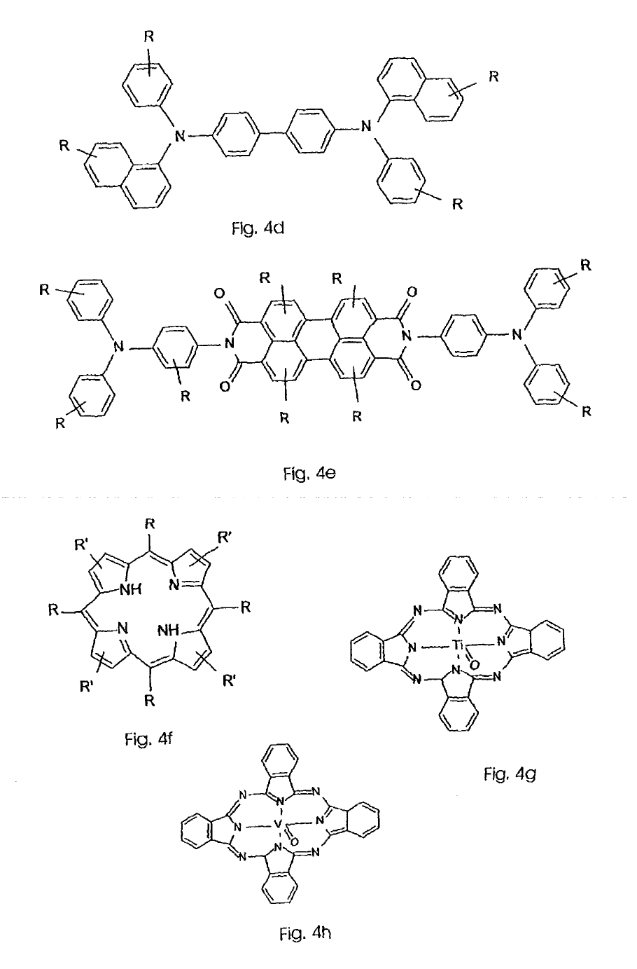

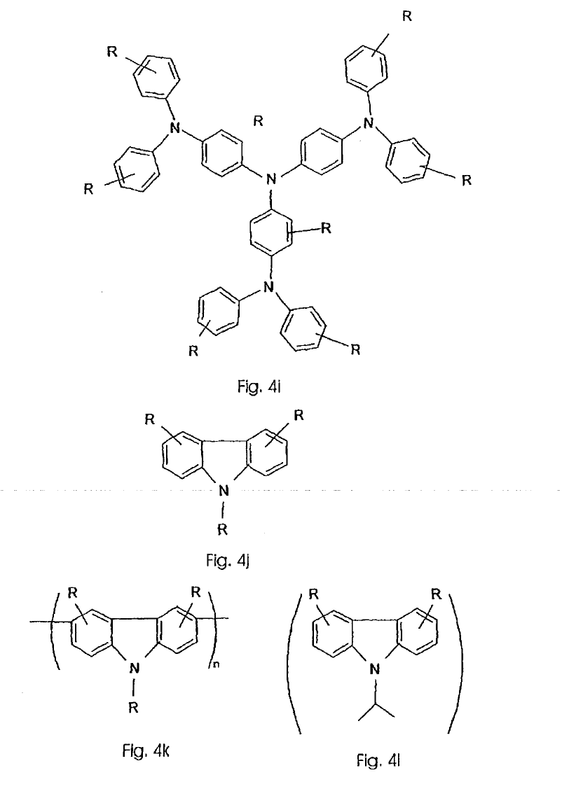

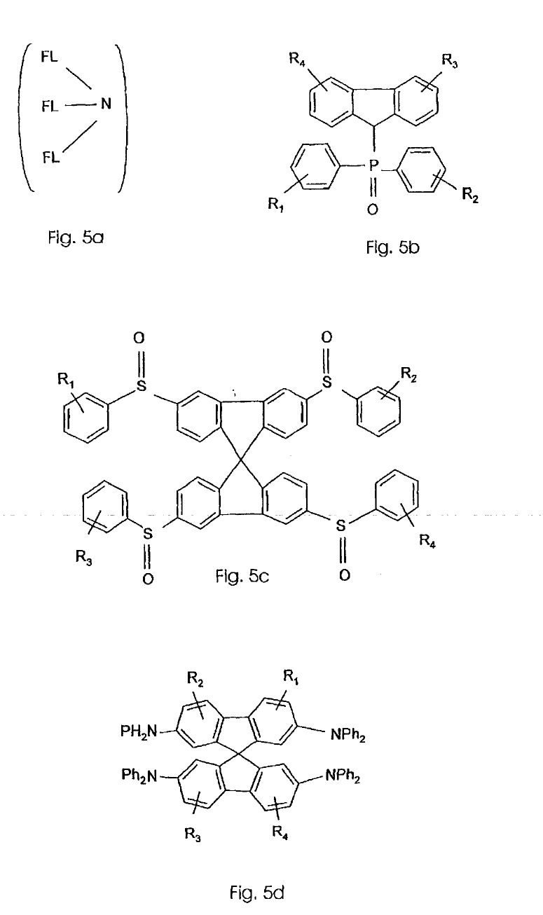

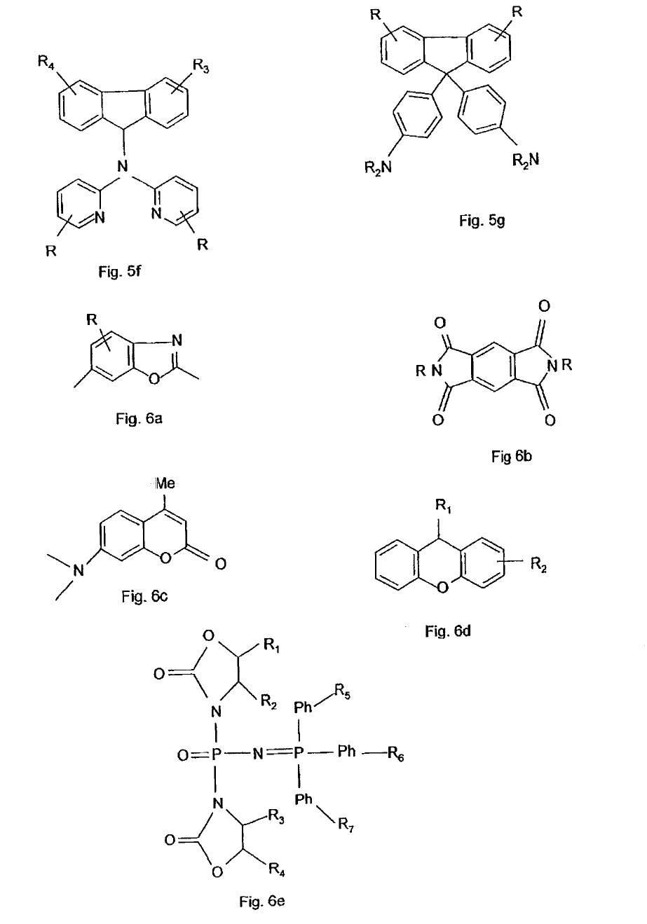

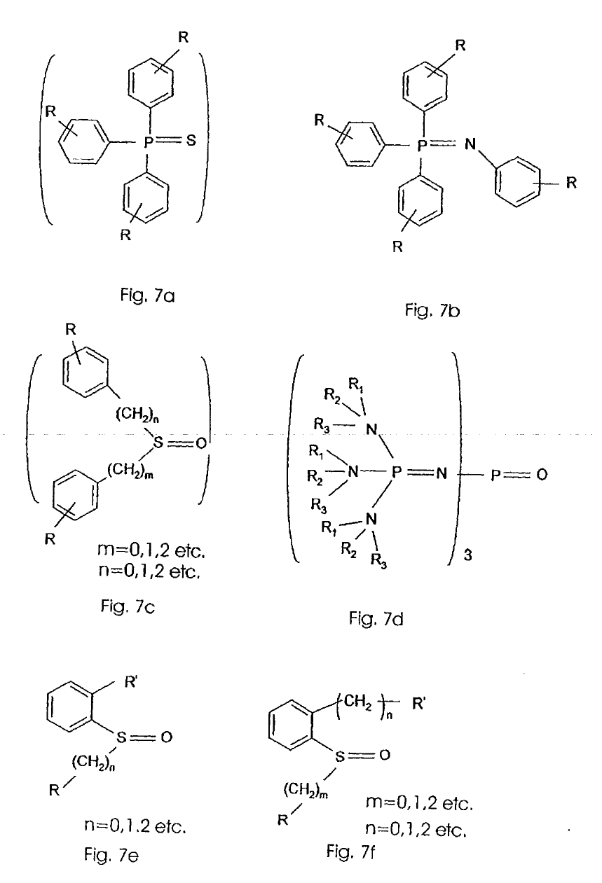

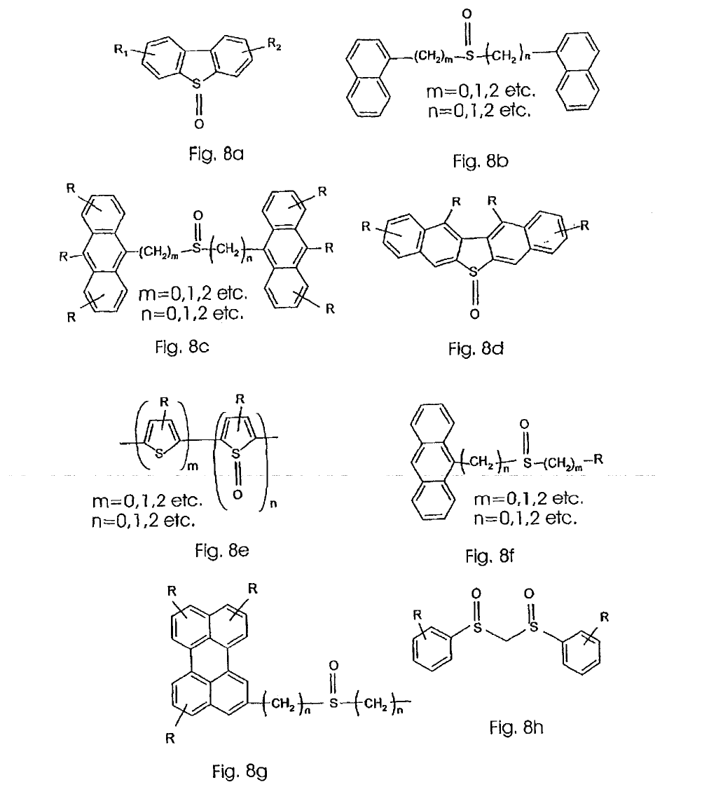

Other examples of Lₚ chelates are as shown in FIG. 4 and fluorene and fluorene derivatives e.g. a shown in FIG. 5 and compounds of formulae as shown as shown in is FIGS. 6 to 8.

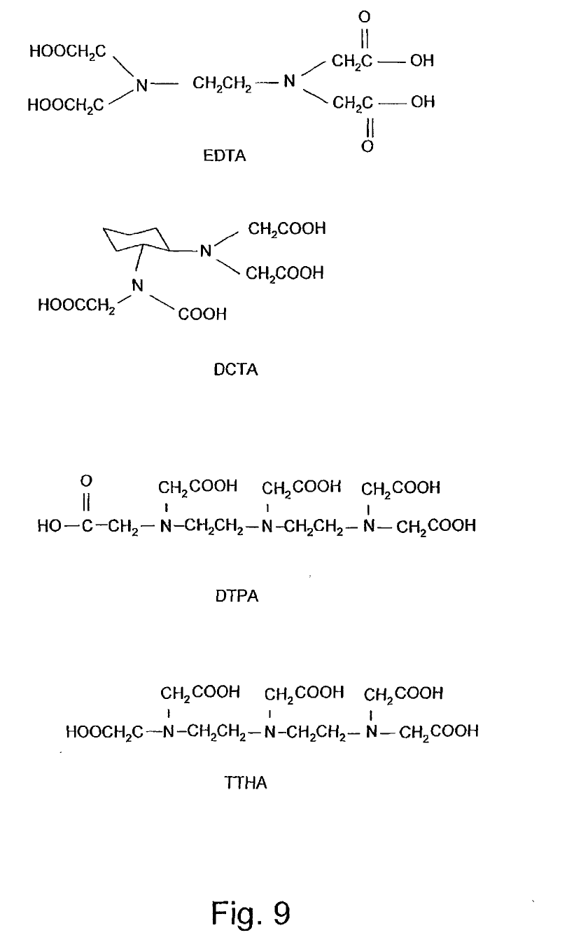

Specific examples of Lα and Lp are tripyridyl and TMHD, and TMHD complexes, α, α′, α″ tripyridyl, crown ethers, cyclans, cryptanls phthalocyanans, porphoryins ethylene diamine tetramine (FDTA), DCTA, DTPA and TTHA. Where TMHD is 2,2,6,6tetramethyl-3,5-heptanedionato and OPNP is diphenylphosphonimide triphenyl phosphorane. The formulae of the polyamines are shown in FIG. 9.

The electroluminescent material can be deposited on the substrate directly by evaporation from a solution of the material in an organic solvent. The solvent which is used will depend on the material but chlorinated hydrocarbons such as dichloromethane, n-methyl pyrrolidone, dimethyl sulphoxide, tetrahydrofuran dimethylformamide etc. are suitable in many cases.

Alternatively the material can be deposited by spin coating from solution or by vacuum deposition from the solid state e.g. by sputtering or any other conventional method can be used.

The first electrode is preferably a transparent substrate such as is a conductive glass or plastic material which acts as the anode, preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate. The electroluminescent material can be deposited on the substrate directly by evaporation from a solution of the material in an organic solvent. The solvent which is used will depend on the material but chlorinated hydrocarbons such as dichloromethane, n-methyl pyrrolidone, dimethyl sulphoxide, tetrahydrofuran dimethylformamide etc. are suitable in many cases.

Alternatively the material can be deposited by spin coating from solution or by vacuum deposition from the solid state e.g. by sputtering or any other methods can be used.

Optionally the hole transporting material can be mixed with the electroluminescent material and co-deposited with it.

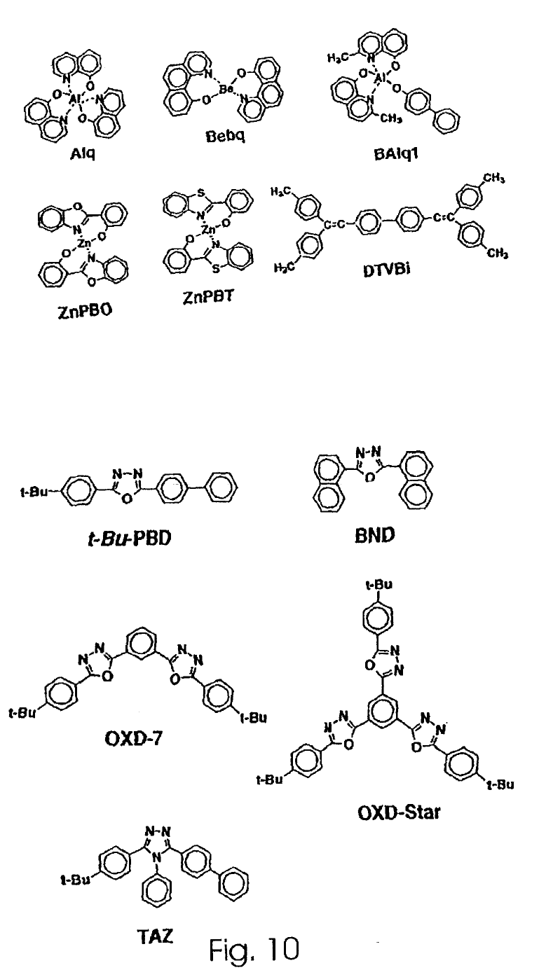

Optionally there is a layer of an electron injecting material between the cathode and the electroluminescent material layer, the electron injecting material is a material which will transport electrons when an electric current is passed through electron injecting materials include a metal complex such as a metal quinolate e.g. an aluminium quinolate, lithium quinolate, a cyano anthracene such as 9,10 dicyano anthracene, cyano substituted aromatic compounds such as polycyanoantbracenes, tetracyanoquinidodimethane a polystyrene sulphonate or a compound with the structural formulae shown in FIG. 10 of the drawings in which the phenyl rings can be substituted with substituents R as defined above. Instead of being a separate layer the electron injecting material can be mixed with the electroluminescent material and co-deposited with it.

The hole transporting materials, the electroluminescent material and the electron injecting materials can be mixed together to form one layer, which simplifies the construction.

The second electrode functions as the cathode and can be any low work function metal e.g. aluminium, calcium, lithium, silver/magnesium alloys, rare earth metal alloys etc., aluminium is a preferred metal. A metal fluoride such as an alkali metal, rare earth metal or their alloys can be used as the second electrode for example by having a metal fluoride layer formed on a metal.

The display of the invention may be monochromatic or polychromatic. Electroluminescent rare earth chelate compounds are known which will emit a range of colours e.g. red, green, and blue light and white light and examples are disclosed in Patent Applications WO98/58037 PCT/GB98/01773, PCT/GB99/03619, PCT/GB99/04030, PCT/GB99/04024, PCT/GB99/04028, PCT/GB00/00268 and can be used to form OLEDs emitting those colours. Thus, a full colour display can be formed by arranging three individual backplanes, each emitting a different primary monochrome colour, on different sides of an optical system, from another side of which a combined colour image can be viewed. Alternatively, rare earth chelate electroluminescent compounds emitting different colours can be fabricated so that adjacent diode pixels in groups of three neighbouring pixels produce red, green and blue light. In a further alternative, field sequential colour filters can be fitted to a white light emitting display.

Either or both electrodes can be formed of silicon and the electroluminescent material and intervening layers of a hole transporting and electron transporting materials can be formed as pixels on the silicon substrate. Preferably each pixel comprises at least one layer of a rare earth chelate electroluminescent material and an (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode the cathode can be formed of a transparent electrode which has a suitable work function, for example by a indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers, for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

As described in WO00/60669 the brightness of light emitted from each pixel is preferably controllable in an analogue manner by adjusting the voltage or current applied by the matrix circuitry or by inputting a digital signal which is converted to an analogue signal in each pixel circuit The substrate preferably also provides data drivers, data converters and scan drivers for processing information to address the array of pixels so as to create images. When an electroluminescent material is used which emits light of a different colour depending on the applied voltage the colour of each pixel can be controlled by the matrix circuitry.

In one embodiment, each pixel is controlled by a switch comprising a voltage controlled element and a variable resistance element, both of which are conveniently formed by metaloxide-semiconductor field effect transistors (MOSFETs)or by an active matrix transistor.

### EXAMPLE 1

Preparation of Poly(aniline) and De-Protonated Poly(aniline)

Aniline was distilled under reduced pressure before use.

Aniline (25.0 g; 0.27 mole) was dissolved in 1M HCl (100 ml) and the mechanically stirred solution was cooled to 0° C. using an ice-dry ice bath, over 25 minutes.

Ammonium persulphate (92.0 g; 0.40 mole) was dissolved in 1M HCl (250 ml) and cooled to 0° C. in the same cooling bath for 30 minutes. The ammonium persulphate solution was added dropwise to the mechanically stirred anilinium hydrochloride solution using a dropping funnel. The temperature of the solution was slowly risen from 0° C. to 38° C. over 20 minutes. The addition took place over 35 minutes. After the addition of all the ammonium persulphate solution, the dark greenish coloured product was stirred in the same cooling bath for further 1.5 hours. The temperature of the final solution containing poly(aniline)hydrochloride was dropped to 5° C. The product was filtered off under suction and the green filter cake was washed thoroughly with water.

The protonated poly(aniline) was transferred into a beaker and deprotonated with 5% ammonium hydroxide solution (500 ml), by mechanically stirring the solution at room temperature for 4 hours. The de-protonated poly(aniline) was filtered off under suction, washed thoroughly with water, suction dried and again transferred into a beaker. The de-protonated poly(aniline) was again mechanically stirred at room temperature with 5% ammonium hydroxide solution (500 ml) for 18 hours. The twice de-protonated poly(aniline) was filtered off under suction, washed with distilled water and finally the water was drained off with ethanol. The de-protonated poly(aniline) was dried under vacuum at 90° C. for 20 hours and was substantially deprotonated. Yield 22 g.

### EXAMPLE 2

Preparation of poly(2-ethyl aniline) and De-Protonated poly(2-ethyl aniline)

2-Ethyl aniline was distilled under reduced pressure and used immediately.

2-Ethyl aniline (100 g; 0.83 mole) was dissolved in 1M HCl (500 ml) and cooled in an ice-bath. Ammonium persulphate (282.5 g; 1.24 mole) was dissolved in 1M HCl (1000 ml) and also cooled in an ice-bath. Ammonium persulphate was added slowly to the mechanically stirred solution of 2-ethyl aniline in HCl. The temperature of the solution was slowly risen and the solution became dark blue in colour. After the addition of all the ammonium persulphate solution the reaction mixture was continuously stirred for further 2.5 hours and filtered off under suction

The poly(2-ethyl aniline) hydrochloride was de-protonated with 5% amnmonium hydroxide solution (1000 ml) by mechanically siring the solution for 18 hours at room temperature. The de-protonated polymer was filtered off under suction and the solid again taken-up with 5% ammonium hydroxide solution (500 ml) and mechanically stirred for 2 hours. The de-protonated poly(2-ethyl aniline) was filtered off under suction and washed thoroughly with de-ionised water, followed by small amounts of ethanol to drain off the water. The product was dried under vacuum at 90° C. for 20 hours. The product was substantially de-protonated.

### EXAMPLE 3

Fabrication of Electroluminescent Device

An ITO coated glass piece (1×1 cm²) had a portion etched out with concentrated hydrochloric acid to remove the ITO and was cleaned and dried. An electroluminescent device was fabricated by sequentially forming on the ITO, by vacuum evaporation, layers comprising:

ITO(120 Ω/sqr)/(PANI 8 nm)/TPD(20 nm)G1 (50 nm)/Alq₃(18 nm)/Al

Where PANI is a deprotonated polyaniline synthesised as in example 1 above, TPD is N,N′-diphenyl-N′-bis (3-methylphenyl)-1,1′-biphenyl-4,4′-diamine, G1 is Tb(TMHD)₃OPNP where TMHD and OPNP are as defined herein and Alq₃ is aluminium quinolate.

The organic coating on the portion which had been etched with the concentrated hydrochloric acid was wiped with a cotton bud. The coated electrodes were stored in a vacuum desiccator over a molecular sieve and phosphorous pentoxide until they were loaded into a vacuum coater (Edwards, 10⁻⁶ torr) and aluminium top contacts made. The active area of the LED's was 0.08 cm by 0.1 cm² the devices were then kept in a vacuum desiccator until the electroluminescence studies were performed.

The ITO electrode was always connected to the positive terminal. The current vs. voltage studies were carried out on a computer controlled Keithly 2400 source meter.

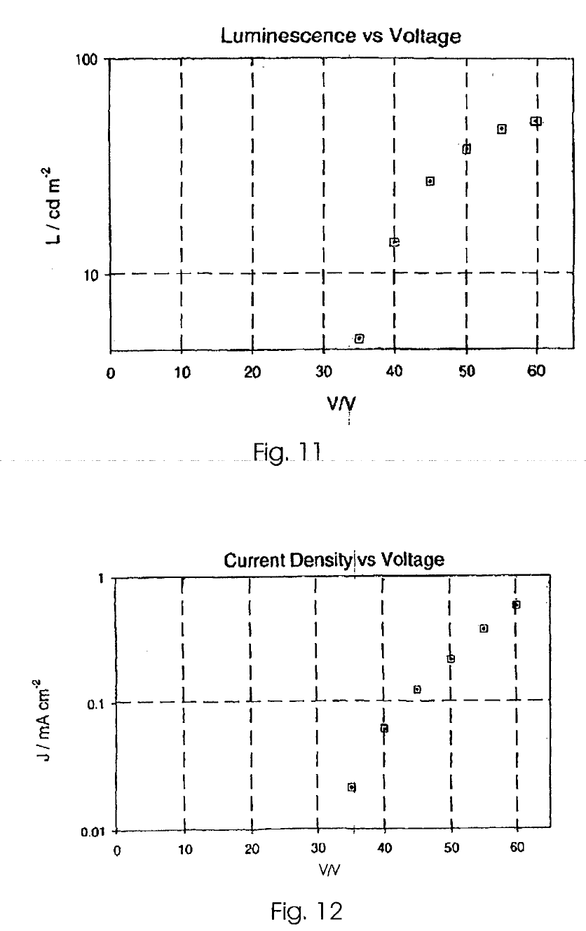

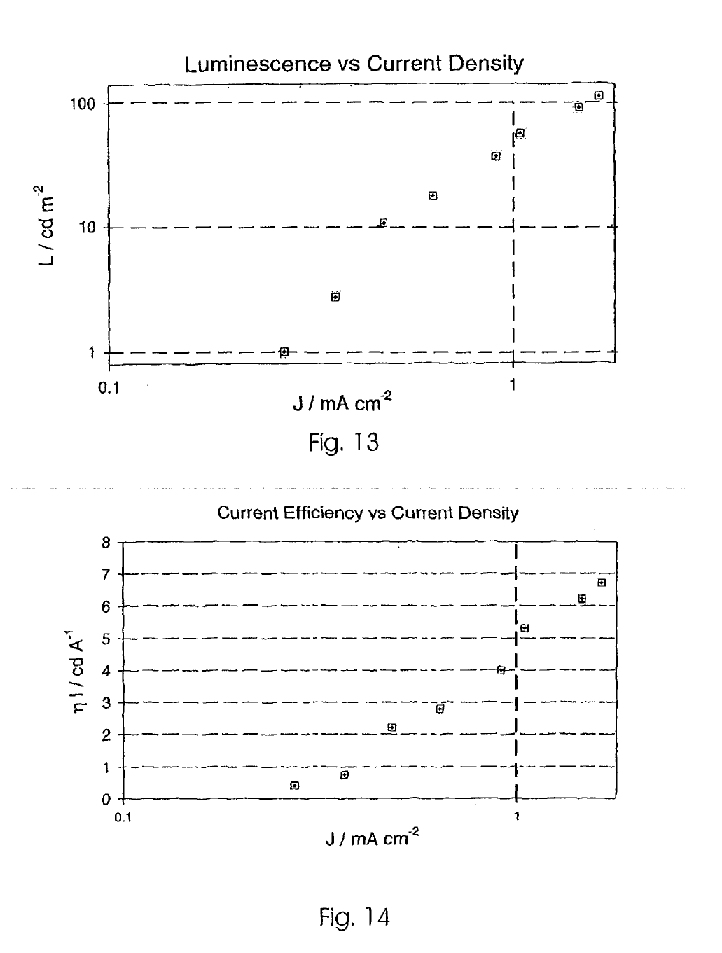

An electric current was applied across the device and light was emitted with a peak wavelength of 548 nm and colour coordinates x=0.31, y=0.61 (CIE Colour Chart 1931) a plot of the luminescence versus voltage is shown in the graph of FIG. 11 a plot of current density versus against voltage is shown in FIG. 12 a plot of lumninescence against current density is shown in FIG. 13 and a plot of current efficiency against current density shown in FIG. 14.

### EXAMPLE 4

Example 3 was repeated except that the TPD was replaced by STAD (spiroTAD) and the device had the structure

ITO(100 Ω/sqr)/(PANI 8 nm)/STAD(20 nm)/G1 (50 nm)/Alq₃ (18 nm)/Al

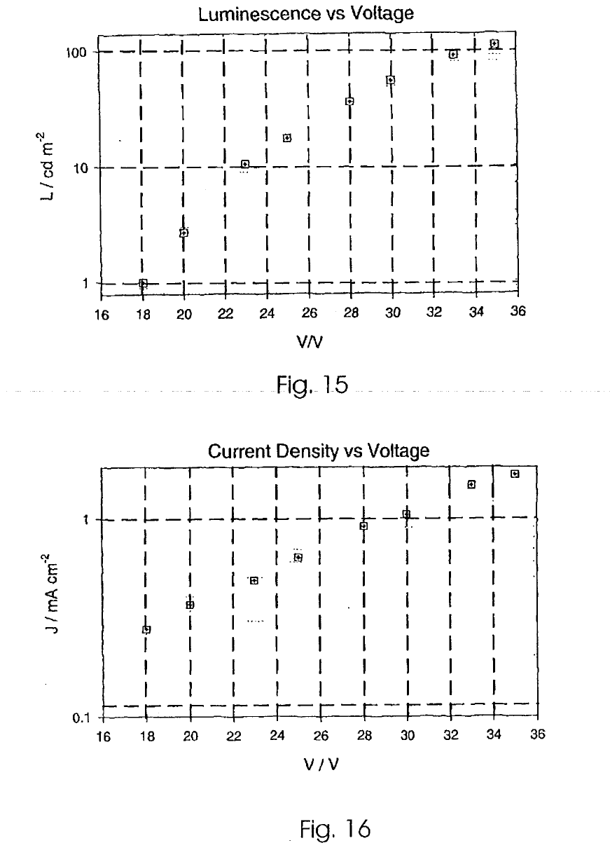

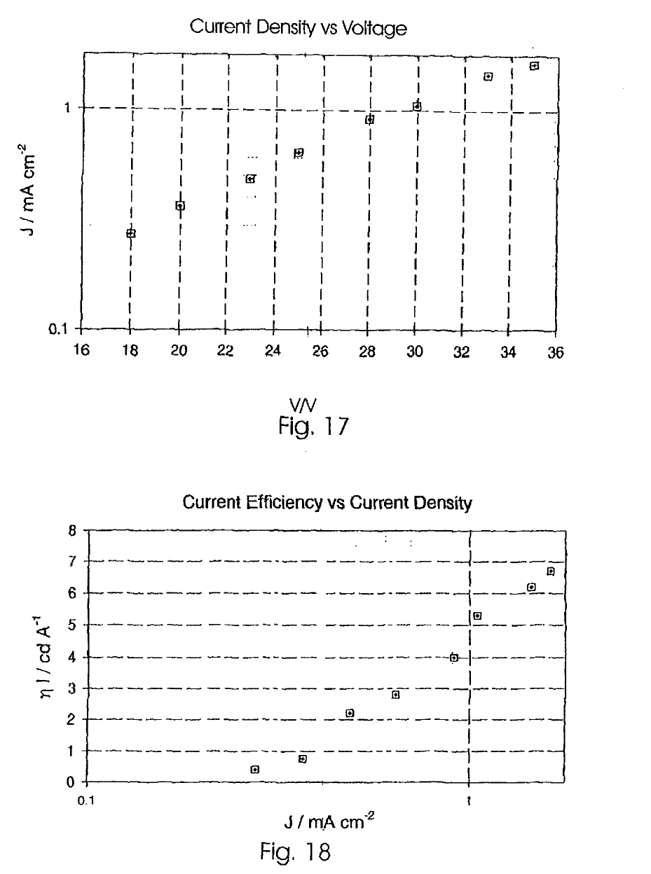

An electric current was applied across the device and light was emitted with a peak wavelength of 548 nm and colour coordinates x=0.31, y=0.61 (CIE Colour Chart 1931) a plot of the luminescence against voltage is shown in the graph of FIG. 15 a plot of luminescence against current density is shown in FIG. 16 a plot of current density against voltage is shown in FIG. 17 and a plot of current efficiency against current density shown in FIG. 18.

### EXAMPLE 5

The procedure of example 3 was repeated to form an electroluminescent device comprising

ITO(100 Ω/sqr)/(POE 12 nm)/MTDATA (13 nm)/STAD(10 nm)G1(50 nm)/Alq₃(18 nm)Al

Where POE is a deprotonated polyorthoethylaniline prepared as in example 2.

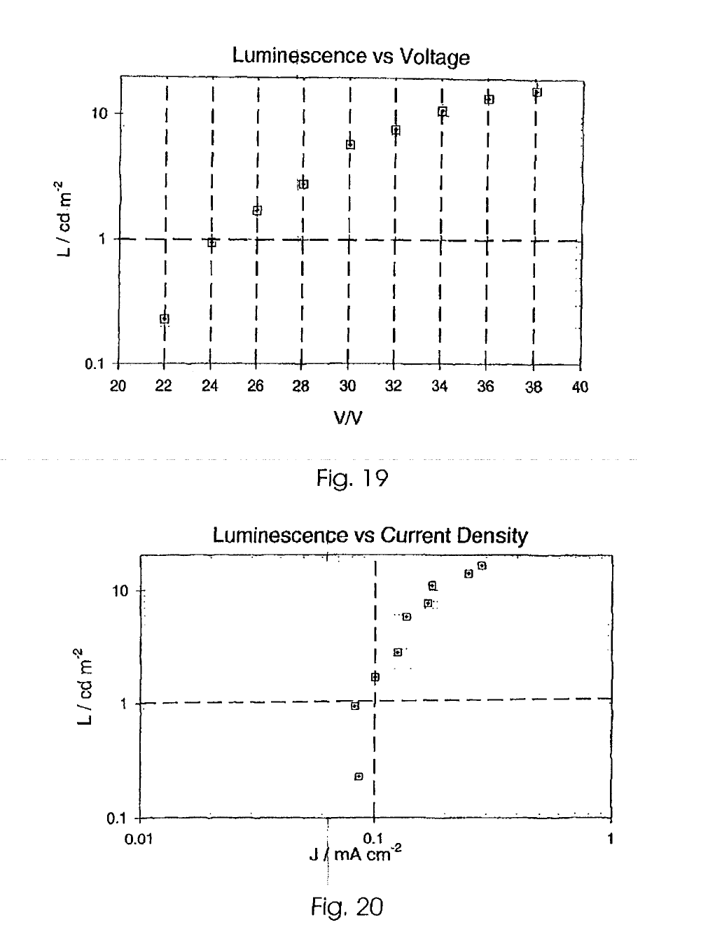

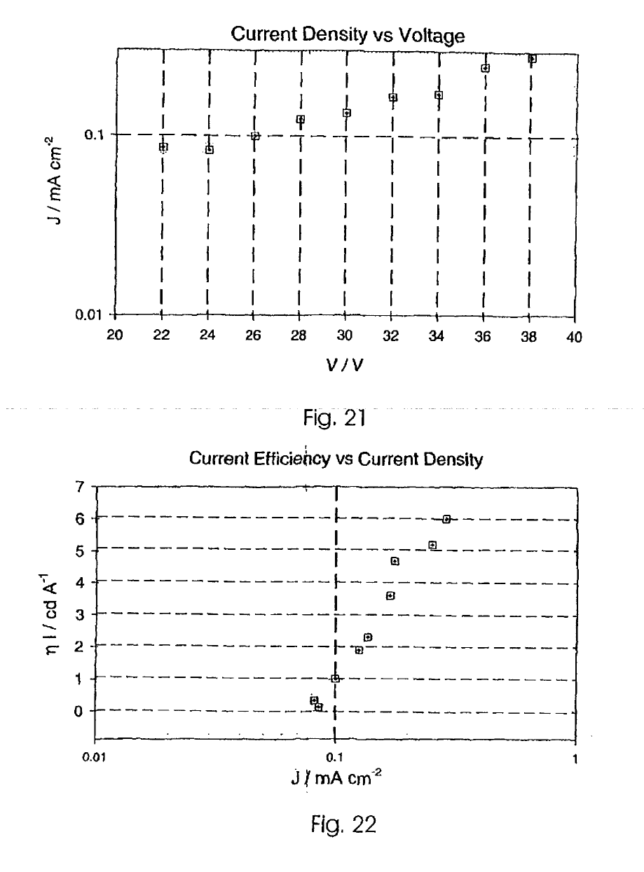

An electric current was applied across the device and light was emitted with a peak wavelength of 548 nm and colour coordinates x=0.32, y=0.61 (CIE Colour Chart 1931) a plot of the luminescence versus voltage is shown in the graph of FIG. 19, a plot of luminescence against current density is shown in FIG. 20, a plot of current density versus voltage is shown in FIG. 21 and a plot of current efficiency against current density shown in FIG. 22.

### EXAMPLE 6

The procedure of example 3 was repeated to form an electroluminescent device comprising

ITO(100 Ω/sqr)/(POE 12 nm)/STAD(20 nm)G1(50 nm)/Alq₃(18 nm)Al

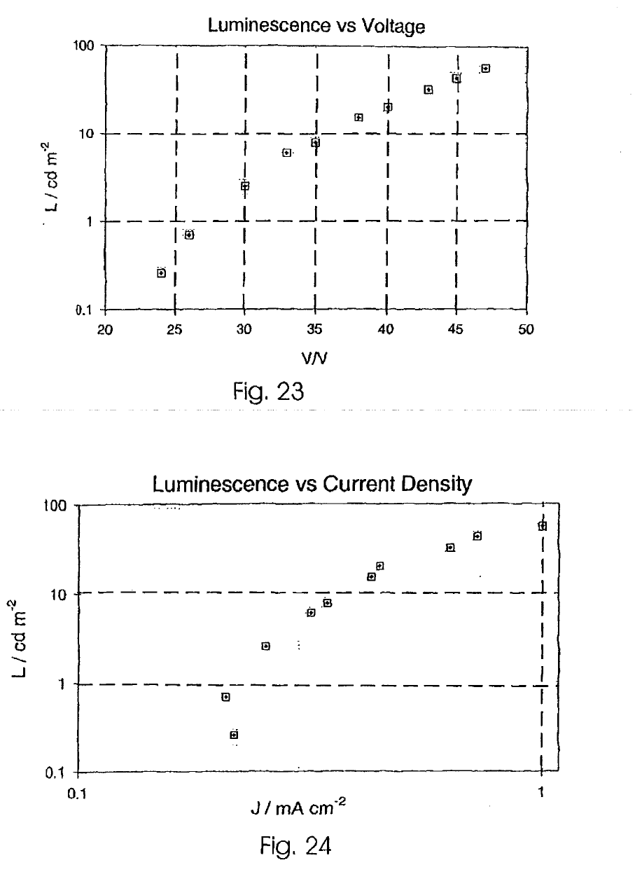

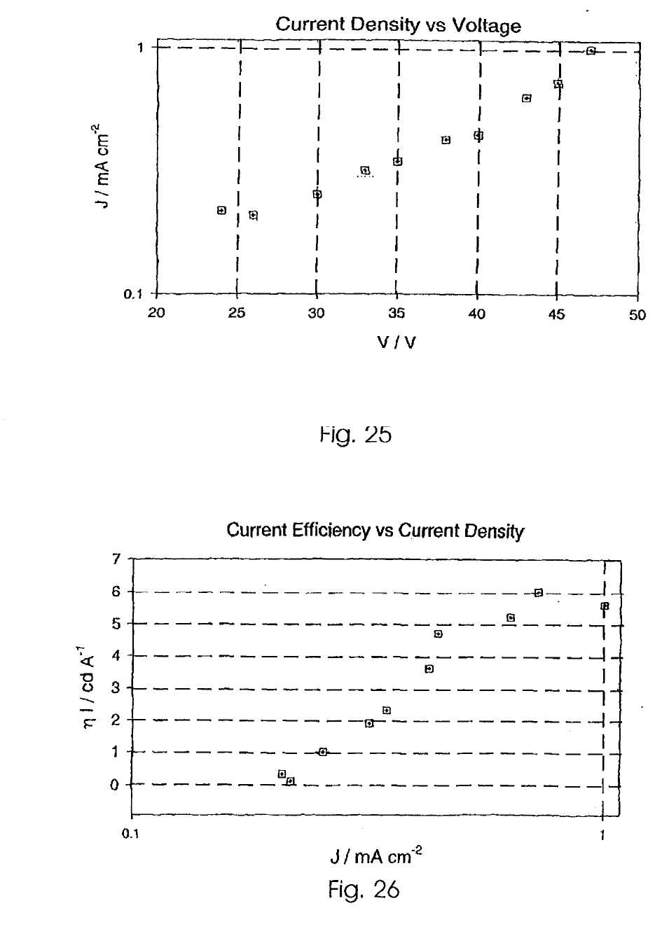

An electric current was applied across the device and light was emitted with a peak wavelength of 548 nm and colour coordinates x=0.31, y=0.61 (CIE Colour Chart 1931) a plot of the luminescence versus voltage is shown in the graph of FIG. 23, a plot of luminescence against current density is shown in FIG. 24, a plot of current density versus voltage is shown in FIG. 25 and a plot of current efficiency against current density shown in FIG. 26.

1. An electroluminescent device comprising sequentially (i) a first electrode, (ii) a layer of an unsubstituted or substituted polymer of an amino substituted aromatic compound as a hole transporting and/or hole injecting layer, (iii) a layer consisting of an electroluminescent material and (iv) a second electrode.

2. An electroluminescent device as claimed in claim 1 in which the polymer of an amino substituted aromatic compound is a copolymer of an aniline monomer of the general formula 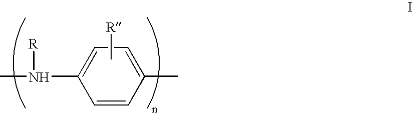
where R is in the ortho- or meta-position and is hydrogen, C1-18 alkyl, C1-6 alkoxy, amino, chloro, bromo, hydroxy or the group 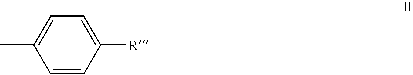
where R″ is alky or aryl and R′″ is hydrogen, C1-6 alkyl or aryl, with at least one other monomer of formula I above:

3. An electroluminescent device as claimed in claim 2 in which the copolymer has the formula 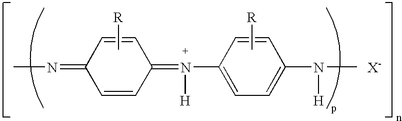
where p is from 1 to 10 and n is from 1 to 20, R is hydrogen, C1-18 alkyl, C1-6 alkoxy, amino, chloro, bromo, hydroxy p is 1 to 20 and n is 1 to 50 and X is an anion.

4. An electroluminescent device as claimed in claim 3 in which the weight average molecular weight of the copolymer is of the order of 30,000.

5. An electroluminescent device as claimed in claim 3 or 4 in which p is four.

6. An electroluminescent device as claimed in any one of claims 1 to 5 in which the unsubstituted or substituted polymer of an amino substituted aromatic compound is deprotonated.

7. An electroluminescent device as claimed in claim 6 in which the unsubstituted or substituted polymer of an amino substituted aromatic compound is an evaporable deprotonated polymer.

8. An electroluminescent device as claimed in claim 7 in which the polymer of the substituted aromatic compound has the formula

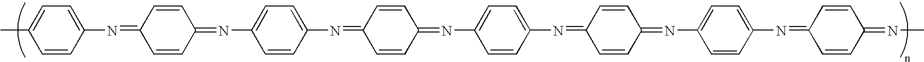

9. An electroluminescent device as claimed in any one of claims 3 to 8 in which X is selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, cellulose sulphate or a perfluorinated polyanion.

10. An electroluminescent device as claimed in any one of claims 3 to 8 in which the copolymer is a copolymer of aniline with o-anisidine, m-sulphanilic acid or o-aminophenol, or o-toluidine with o-aminophenol, o-ethylaniline or o-phenylene diamine.

11. An electroluminescent device as claimed in claim 1 or claims 4 to 9 as dependant on claim 1 in which the polymer of an amino substituted aromatic compound is a polymer selected from substituted or unsubstituted polyaminonapthalenes, polyaminoanthracenes, polyamino phenanthrenes.

12. An electroluminescent device as claimed in any one of the preceding claims in which the first electrode is a transparent conductive glass or plastic material, a conductive polymer or conductive polymer coated glass or plastics material.

13. An electroluminescent device as claimed in any one of the preceding claims in which the electroluminescent material is an organo metallic complex of formula 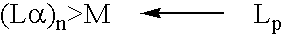
where Lα and Lp are organic ligands, M is a rare earth, transition metal, lanthanide or an actinide and n is the valence state of the metal M and in which the ligands Lα are the same or different.

14. An electroluminescent device as claimed in claim 13 in which there are a plurality of ligands Lp which can be the same or different.

15. An electroluminescent device as claimed in any one of the preceding claims in which the electroluminescent material is an organo metallic complex of formula (Lₙ)ₙM₁M₂ or (Lₙ)ₙM₁M₂ (Lₚ), where Lₙ is Lα, Lₚ is a neutral ligand M₁ is a rare earth, transition metal, lanthanide or an actinide, M₂ is a non rare earth metal and n is the combined valence state of M₁ and M₂.

16. An electroluminescent device as claimed in any one of the preceding claims in which the electroluminescent material is a binuclear, trinuclear or polynuclear organometallic complex of formula
(Lm)ₓM₁←M₂(Ln)_{y} or 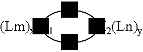
where L is a bridging ligand and where M₁ is a rare earth metal and M₂ is M₁ or a non rare earth metal, Lm and Ln are the same or different organic ligands Lα as defined above, x is the valence state of M₁ and y is the valence state of M₂ or
(Lm)ₓM₁-M₃(Ln)_{y}-M₂(Lp)_{z}
or 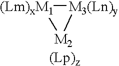
where M₁, M₂ and M₃ are the same or different rare earth metals and Lm, Ln and Lp are organic ligands Lα and x is the valence state of M₁, y is the valence state of M₂ and z is the valence state of M₃ and Lp can be the same as Lm and Ln or different or 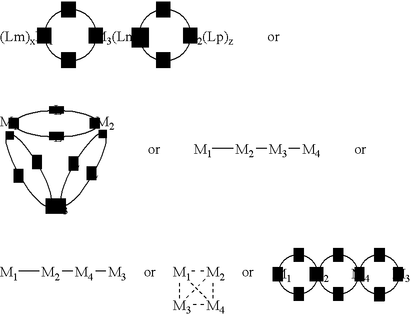
where M₄ is M₁ and L is a bridging ligand and in which the rare earth metals and the non rare earth metals can be joined together by a metal to metal bond and/or via an intermediate bridging atom, ligand or molecular group or in which there are more than three metals joined by metal to metal bonds and/or via intermediate ligands and

17. An electroluminescent device as claimed in any one of claims 13 to 16 in which Lα has the formula (IV) to (XVIII) herein.

18. An electroluminescent device as claimed in any one of claims 13 to 17 in which Lp has the formula of FIGS. 1 to 8 of the accompanying drawings or of formula (XIX) to (XXV) herein.

19. An electroluminescent device as claimed in any one of claims 13 to 18 in which the said rare earth, transition metal, lanthanide or an actinide is selected from Sm(III), Eu(II), Eu(III), Tb(III), Dy(III), Yb(III), Lu(III), Gd (III), Gd(III) U(III), Tm(III), Ce (III), Pr(III), Nd(III), Pm(III), Dy(III), Ho(III) and Er(III).

20. An electroluminescent device as claimed in any one of the preceding claims in which there is a layer of an electron injecting material between the cathode and the electroluminescent material layer.

21. An electroluminescent device as claimed in claim 20 in which the electron injecting material is selected from metal quinolates, a cyano-anthracene, 9,10 dicyano-anthracene, a polystyrene-sulphonate, aluminium quinolate and lithium quinolate or has the formula of FIG. 10 of the drawings.

22. An electroluminescent device as claimed in any one of the preceding claims in which the second electrode is aluminium, calcium, lithium, or a silver/magnesium alloys.
